(19) United States
(12) Patent Application Publication
(10) Pub. No.: US 2007/0013681 A1
(43) Pub. Date: Jan. 18, 2007

(54) Ambidextrous Multi-function Finger Adaptor

(76) Inventor: Joseph C Chou, Alhambra, CA (US)

Correspondence Address: CHEIN-HWA S. TSAO, 6684 MT PAKRON DRIVE, SAN JOSE, CA, 95120, US

(21) Appl. No.: 11/160,838

(22) Filed: Jul. 12, 2005

(51) Int. Cl. G09G 5/00

(52) U.S. Cl. 345/179

(57) ABSTRACT

An ambidextrous multi-function finger adaptor is proposed to facilitate the operation of various electronic equipments by the finger. The finger adaptor includes a removable wearing device for fixably enclosing a portion of the finger covering at least the finger pad. A first stylus tip is affixed to and projected from the removable wearing device at a first stylus location on the finger pad but offset from center of the finger pad toward a first edge of the finger. A second stylus tip is affixed to and projected from the removable wearing device at a second stylus location on the finger pad but offset from center of the finger pad toward a second edge of the finger. A third stylus tip is affixed to and projected from the removable wearing device at a third stylus location on the finger pad near a sensible center of feeling for writing.

The present invention relates generally to the field of human-equipment interface. More particularity, the present invention is directed to an adaptor for facilitating the operation of equipments by the human hands.

### DESCRIPTION OF THE RELATED ART

Numerous adaptive apparatus for facilitating the operation of equipments by the human hands have existed for centuries of the human civilization. A common example are numerous types of gloves performing a variety of functions ranging from physical protection to sterilization. With the advent of modern day microelectronics and its associated human-operable precision, miniature equipments, frequently the human fingers are found to be too big to conveniently and reliably operate these equipments. To improve this situation, various mechanical apparatus are conceived to be worn over the finger to reduce the effective size of the finger.

In U.S. Pat. No. 5,314,260 entitled “Finger Pen” of Jan Andersson, dated May 24, 1994, Andersson described a finger pen apparatus which may be removably attached to a finger such that the pen is held in a prone position by which is meant that the pen is held in place with the palm of the hand turned downward facing the surface which is to be written upon. The finger pen comprises a sleeve removably attachable to a finger and a pen tip protruding from the sleeve at an angle and in communication with a container for supplying paste, ink or the like to the pen tip.

In U.S. Pat. No. 6,249,277 entitled “Finger-mounted stylus for computer touch screen” of Nicholas Varveris, dated Jun. 19, 2001, Varveris described a finger stylus for a touch screen. The finger stylus includes a flexible non-metallic elastic ring or a flexible, fabric-like strap having distal ends. Each of the distal ends includes parts of an interconnect fastener such as a hooks and loops or a magnetic fastener. The ring or strap forms a wraparound for a human fingertip such that the bonding of the interconnect fastener parts about the fingertip or the elasticity of the ring firmly hold the strap against the fingertip. The ring or strap includes an intermediate portion including a loophole extending from an exterior surface of the intermediate portion which receives a longitudinal stylus rod extending through the loophole. The rod in use is positioned to extend through the loophole generally transversely to the strap and above and beyond a user's fingertip for touching a touch screen.

As the variety of modern day miniature electronic equipments continues to proliferate, such as cellular telephones, portable game boxes, lap top and notebook computers and numerous Personal Digital Assistants (PDA), a highly flexible, convenient to use, multi-function mechanical apparatus is desired to be worn over the finger to facilitate their operations.

### SUMMARY OF THE INVENTION

An ambidextrous multi-function finger adaptor is proposed to facilitate the operation of various electronic equipments by the finger. A right-handed X-Y-Z Cartesian coordinate system is referenced wherein the finger tip points to the negative Y-direction with Y=0 on the finger pad corresponding to a sensible center of feeling of the finger for pushing a button, the direction from the finger pad to the finger nail points to the Z-direction and the plane X=0 being symmetrically dissecting the finger. The finger adaptor includes:
a) A removable wearing device for fixably enclosing a portion of the finger covering at least the finger pad.
b) A first stylus tip affixed to and projected from the removable wearing device at a first stylus location of Y=0 on the finger pad but offset from X=0 in the negative X-direction to a location between X=0 and the edge of the finger. The first stylus tip acts to ergonomically push functional buttons of an electronic equipment with a first equipment user's hand of which the finger is a part of.
c) A second stylus tip affixed to and projected from the removable wearing device at a second stylus location of Y=0 on the finger pad but offset from X=0 in the positive X-direction to a location between X=0 and the edge of the finger. The second stylus tip also acts to ergonomically push functional buttons of an electronic equipment with a second equipment user's hand of which the finger is a part of.

In one instance of application, the finger is a thumb, the first equipment user's hand is the user's right hand with the corresponding electronic equipment being a cellular telephone operated single-handed by the thumb through the first stylus tip.

In another instance of application, the finger is a thumb, the second equipment user's hand is the user's left hand with the corresponding electronic equipment being a cellular telephone operated single-handed by the thumb through the second stylus tip.

In another instance of application, the finger is a thumb, the second equipment user's hand is the user's right hand with the corresponding electronic equipment being a lap top or a notebook computer whose touch pad is operated by the thumb through the second stylus tip.

In yet another instance of application, the finger is a thumb, the first equipment user's hand is the user's left hand with the corresponding electronic equipment being a lap top or a notebook computer whose touch pad is operated by the thumb through the first stylus tip.

In another embodiment, the ambidextrous multi-function finger adaptor further includes a third stylus tip affixed to and projected from the removable wearing device at a third stylus location near X=0 and Y=0 on the finger pad. The third stylus tip acts to ergonomically write a graphic tablet of an electronic equipment.

In one instance of application of the above, the finger can be an index finger, a middle finger, a ring finger or a little finger with the corresponding electronic equipment being a personal digital assistant.

In yet another embodiment, the ambidextrous multi-function finger adaptor further includes a removable attaching element located on the removable wearing device. The removable attaching element functions to attach the multi-function finger adaptor, while it is not being used by a user for operating an equipment, onto the equipment for convenience and prevention of misplacement.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawing, in which like reference characters designate the same or similar parts throughout the several views, and wherein:

FIG. 1A through FIG. 1D illustrate the ambidextrous multi-function finger adaptor in its as-worn position with various directional and sectional views;

FIG. 2A through FIG. 2C illustrate various embodiments of the removable wearing device portion of the ambidextrous multi-function finger adaptor;

FIG. 3A and FIG. 3B illustrate two instances of application of the ambidextrous multi-function finger adaptor to a cellular telephone;

FIG. 3C and FIG. 3D illustrate two instances of application of the ambidextrous multi-function finger adaptor to a lap top computer; and

FIG. 3E and FIG. 3F illustrate two more instances of application of the ambidextrous multi-function finger adaptor to a PDA.

### DETAILED DESCRIPTION OF THE PREFERRED EMBODIMENTS

In the following detailed description of the present invention, numerous specific details are set forth in order to provide a thorough understanding of the present invention. However, it will become obvious to those skilled in the art that the present invention may be practiced without these specific details. In other instances, well-known methods, procedures, materials and components have not been described in detail to avoid unnecessary obscuring aspects of the present invention. The detailed description is presented largely in terms of simplified perspective and sectional views. These descriptions and representations are the means used by those experienced or skilled in the art to concisely and most effectively convey the substance of their work to others skilled in the art.

Reference herein to “one embodiment” or an “embodiment” means that a particular feature, structure, or characteristics described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of process flow representing one or more embodiments of the invention do not inherently indicate any particular order nor imply any limitations of the invention.

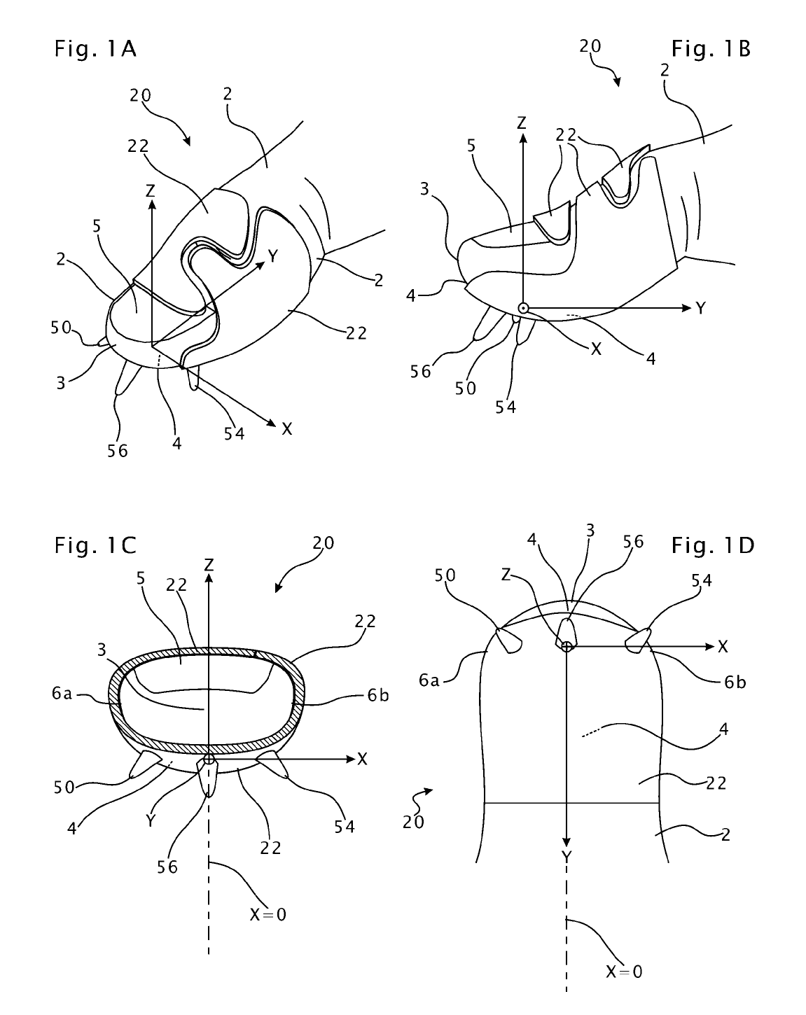

FIG. 1A through FIG. 1D illustrate the ambidextrous multi-function finger adaptor 20 of the present invention, in its as-worn position on a finger 2. FIG. 1A is a perspective view, FIG. 1B is a side view, FIG. 1C is an end view in combination with partial sectional view and FIG. 1D is a bottom view. For convenience of geometric illustration, a right-handed X-Y-Z Cartesian coordinate system is superimposed herein as a reference. Thus, the finger tip 3 is pointing in the negative Y-direction with Y=0 on the finger pad 4 corresponding to a sensible center of feeling of the finger 2 for pushing a button. The direction from the finger pad 4 to the finger nail 5 is the Z-direction while the plane X=0 would symmetrically dissect the finger 2. The finger adaptor 20 includes a removable wearing device 22 for fixably enclosing a portion of the finger 2 covering at least the finger pad 4. In this embodiment the removable wearing device 22 is a resilient shell form snugly enclosing the finger 2 so as to prevent any significant relative movement there between. However, when not being used the finger adaptor 20 can be forcefully pried off thus removed from the finger 2. More detailed structural description and additional embodiments of the removable wearing device 22 will be presently described. Notice that, depending upon the application, the finger 2 can be a thumb, an index, a middle, a ring or a little finger.

A first stylus tip 50 is affixed to and projected from the removable wearing device 22 at a first stylus location of Y=0 on the finger pad 4 but offset from the plane X=0 in the negative X-direction to a location between X=0 and the finger edge 6a. As will be presently illustrated with numerous applications, the first stylus tip 50 functions to ergonomically push functional buttons of an equipment with a first equipment user's hand of which the finger 2 is a part of. As a mirror image with respect to the X-plane, a second stylus tip 54 is affixed to and projected from the removable wearing device 22 at a second stylus location of Y=0 on the finger pad 4 but offset from the plane X=0 in the positive X-direction to a location between X=0 and the finger edge 6b. As will also be presently illustrated with numerous applications, the second stylus tip 54 functions to ergonomically push functional buttons of an equipment with a second equipment user's hand of which the finger 2 is a part of. Notice an additional third stylus tip 56 is affixed to and projected from the removable wearing device 22 at a third stylus location near X=0 and Y=0 on the finger pad 4. As will also be presently illustrated with numerous applications, the third stylus tip 56 functions to ergonomically write, under control of the finger 2, a graphic tablet of an equipment.

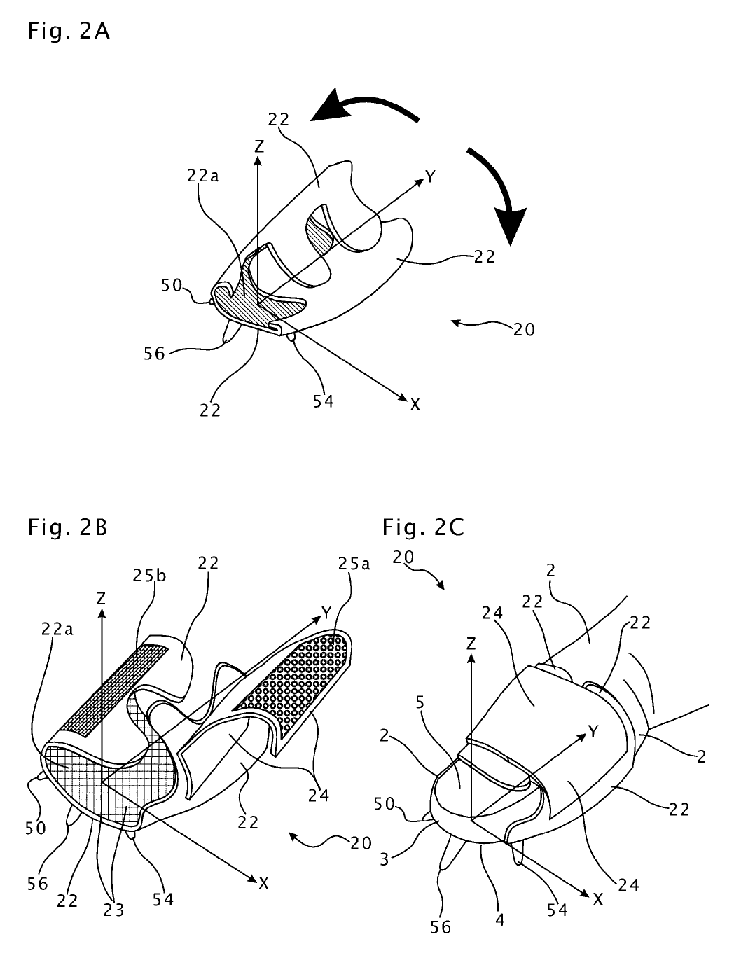

FIG. 2A through FIG. 2C illustrate various embodiments of the removable wearing device 22 portion of the ambidextrous multi-function finger adaptor 20. FIG. 2A illustrates the same finger adaptor 20 of FIG. 1A through FIG. 1D in its free form. That is, after its removal from the user's finger 2. Notice that, relative to FIG. 1A, the free form removable wearing device 22 illustrated in FIG. 2A is a substantially more tightly folded and flattened shell form with a now visible intimate wearing surface 22a. In this form the non-operating finger adaptor 20 is quite convenient to carry around, in fact it can be made easily attachable to the equipment to be operated upon by the user through the finger adaptor 20 and this will be presently described. As the removable wearing device 22 is made of a resilient material, upon forceful insertion of a user's finger 2 into the folded and flattened shell form the correspondingly generated restoring force creates a snug gripping of the finger 2 by the stress-expanded removable wearing device 22 as already shown in FIG. 1A. The stress-expansion of the folded and flattened removable wearing device 22 is further illustrated with two expanding arrows in FIG. 2A. As examples, the removable wearing device 22 can be made of resilient materials such as rubber or plastic of proper durometer and thickness. The resilient material can also be a woven elastomeric fabric or leather. The resilient material can even be a ductile sheet metal form such as copper, gold, zinc or their alloys. FIG. 2B illustrates another embodiment of the free form removable wearing device 22 that is over-sized compared to the user's finger 2. One half of the removable wearing device 22 is provided with a enclosing flap 24 whose inner surface has a fastening pad one 25a affixed thereon. Correspondingly, the outer surface of the other half of the removable wearing device 22 has a fastening pad two 25b affixed thereon. After the insertion of the user's finger 2 and upon a tightening folding of the fastening pad one 25a onto the fastening pad two 25b the two pads become tightly fastened to each other, while still allowing a later easy manual separation, thus creating a snug gripping of the finger 2 by the removable wearing device 22 and this is illustrated in FIG. 2C. An embodiment of the two pads 25a and 25b can use Velcro™ that is in turn made of a hook and loop type material. Another embodiment of the two pads 25a and 25b can use a press on/pry off button configuration. Owing to the tight fastening action of the two pads 25a and 25b, the material choice of the rest of the removable wearing device 22 are many, including rubber, plastic, fabric, leather and sheet metal form. Additionally, FIG. 2B illustrates yet another embodiment wherein the intimate wearing surface 22a of the removable wearing device 22 is provided with frictional surface textures 23 to further reduce the relative movement between the finger adaptor 20 and the user's finger 2.

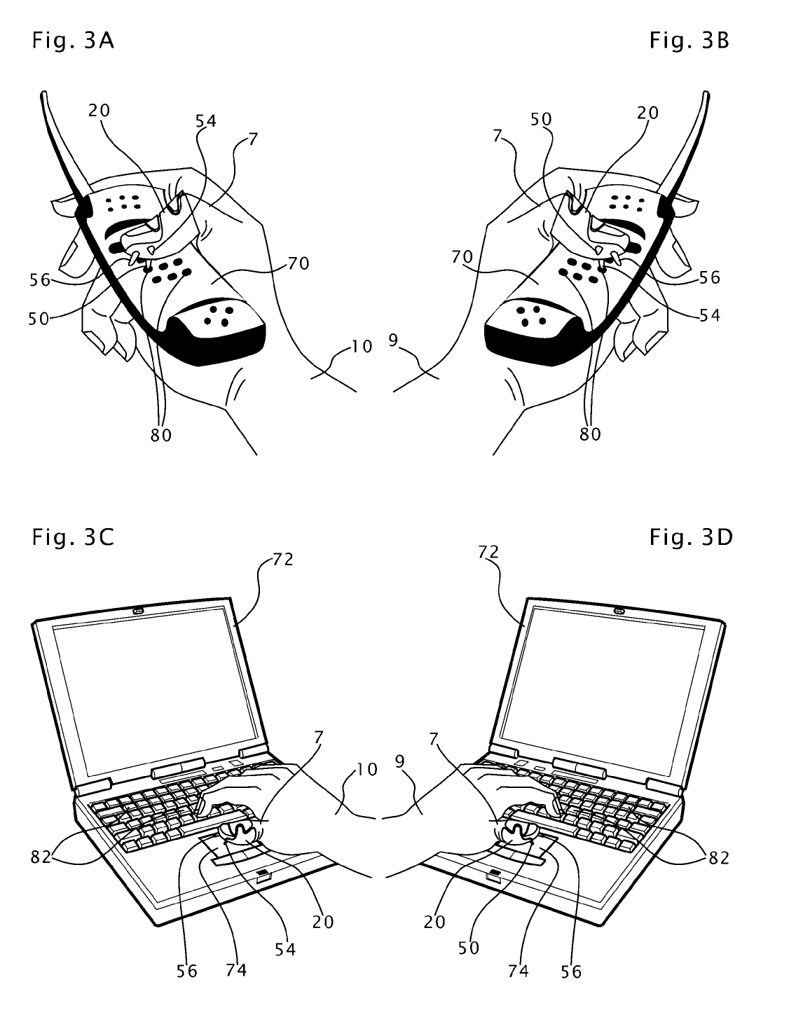

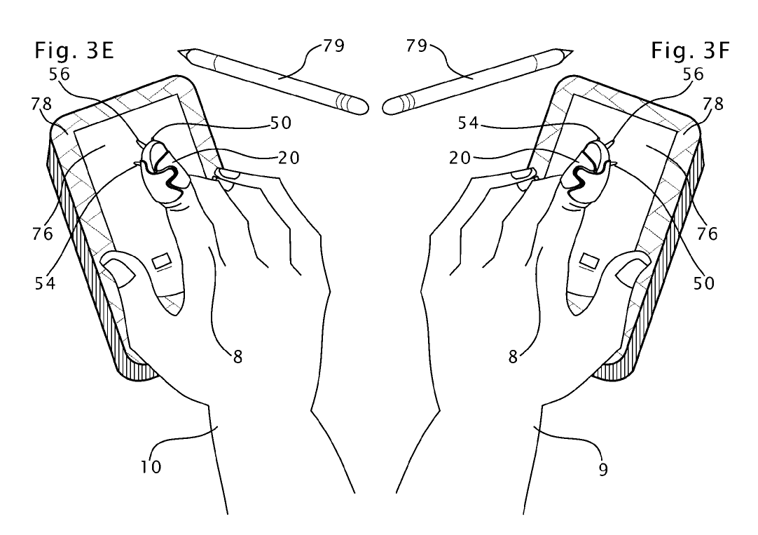

FIG. 3A and FIG. 3B illustrate two instances of application of the ambidextrous multi-function finger adaptor 20 to a cellular telephone 70. FIG. 3A illustrates a single-handed holding and operation of the cellular telephone 70 with a user's right hand 10. Owing to the biological structure of the human hand, in this application it is most natural to wear the finger adaptor 20 on the user's right thumb 7 while pushing the cellular telephone functional buttons 80 with the first stylus tip 50 leaving the second stylus tip 54 and the third stylus tip 56 in a non-interfering position. As a mirror image, FIG. 3B illustrates a single-handed holding and operation of the cellular telephone 70 with a user's left hand 9. Owing to the biological structure of the human hand, in this application it is most natural to wear the finger adaptor 20 on the user's left thumb 7 while pushing the cellular telephone functional buttons 80 with the second stylus tip 54 leaving the first stylus tip 50 and the third stylus tip 56 in a non-interfering position.

FIG. 3C and FIG. 3D illustrate two more instances of application of the ambidextrous multi-function finger adaptor 20 to a lap top computer 72. FIG. 3C illustrates a single-handed operation of the lap top computer 72 with a user's right hand 10. Owing to the biological structure of the human hand, in this application it is most natural to wear the finger adaptor 20 on the user's right thumb 7 while tracing the lap top computer touch pad 74 with the second stylus tip 54 leaving the first stylus tip 50 and the third stylus tip 56 in a non-interfering position. Meanwhile, the rest of the right hand 10 fingers can operate the functional keys 82. As a mirror image, FIG. 3D illustrates a single-handed operation of the lap top computer 72 with a user's left hand 9. Owing to the biological structure of the human hand, in this application it is most natural to wear the finger adaptor 20 on the user's left thumb 7 while tracing the lap top computer touch pad 74 with the first stylus tip 50 leaving the second stylus tip 54 and the third stylus tip 56 in a non-interfering position. Meanwhile, the rest of the left hand 9 fingers can operate the functional keys 82.

Through numerous instances of application including those illustrated in FIG. 3A through FIG. 3D, the first stylus location of Y=0 on the finger pad 4 is preferably offset from the plane X=0 in the negative X-direction to a location from about one third to about two thirds of the distance between X=0 and the finger edge 6a. Likewise, the second stylus location of Y=0 on the finger pad 4 is preferably offset from the plane X=0 in the positive X-direction to a location from about one third to about two thirds of the distance between X=0 and the finger edge 6b.

FIG. 3E and FIG. 3F illustrate two more instances of application of the ambidextrous multi-function finger adaptor 20 to a PDA 78. FIG. 3E illustrates a single-handed operation of the PDA 78 with a user's right hand 10. Owing to the biological structure of the human hand, in this application it is most natural to wear the finger adaptor 20 on the user's right index finger 8 while writing on the PDA graphic tablet 76 with the third stylus tip 56 leaving the first stylus tip 50 and the second stylus tip 54 in a non-interfering position. In this application, the traditional PDA tablet pen 79 is therefore replaced with the combination of the finger adaptor 20 and the index finger 8. It is further remarked that, albeit not as natural, the writing finger can instead be a middle finger, a ring finger or a little finger. As a mirror image, FIG. 3F illustrates a single-handed operation of the PDA 78 with a user's left hand 9. Owing to the biological structure of the human hand, in this application it is most natural to wear the finger adaptor 20 on the user's left index finger 8 while still writing on the PDA graphic tablet 76 with the third stylus tip 56 leaving the first stylus tip 50 and the second stylus tip 54 in a non-interfering position. In this application, the traditional PDA tablet pen 79 is therefore replaced with the combination of the finger adaptor 20 and the index finger 8, etc. By now it should also become clear that, back to the applications on cellular telephone 70 depicted in FIG. 3A and FIG. 3B, should the cellular telephone 70 also be equipped with a graphic tablet similar first stylus tip 50 and second stylus tip 54 would also effectively operate the graphic tablet. Conversely, in FIG. 3E and FIG. 3F should the PDA 78 also be equipped with functional push buttons the third stylus tip 56 would also effectively operate the functional push buttons as well. Additionally, should the PDA user decide to operate the graphic tablet 76 with one hand, the first stylus tip 50 or the second stylus tip 54 would naturally be used through the user's thumb instead, etc. Hence, the present invention is really meant for ergonomically operating an equipment in a general sense. Another significance of the present invention is that, owing to the small size of its various stylus tips, it would allow the operated part of the equipment, be it a push button, a keyboard, a graphic tablet or otherwise, to be designed correspondingly smaller resulting in a more compact equipment.

Due to its small size, it is highly desirable to make the non-operating finger adaptor 20 (FIG. 2A and FIG. 2B) easily attachable to and removable from the equipment to be operated upon by the user. The benefits are convenience of storage and prevention of misplacement of the finger adaptor 20. This can be implemented with an arrangement similar to the two fastening pads 25a and 25b of FIG. 2B. For example, while not graphically illustrated here to avoid unnecessary obscuring details, another fastening pad similar to the fastening pad one 25a can be added to the underside of the finger adaptor 20 while another fastening pad similar to the fastening pad two 25b can be correspondingly added to the equipment for this purpose, etc.

As described with numerous exemplary embodiments and applications, an ambidextrous multi-function finger adaptor having multiple, ergonomically located and oriented stylus tips is proposed to facilitate the operation of various electronic equipments by a finger of either a left hand or a right hand. However, for those skilled in this field, these exemplary embodiments can be easily adapted and modified to suit additional applications without departing from the spirit and scope of this invention. Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

What is claimed is:

1. An ambidextrous multi-function finger adaptor for facilitating the operation of equipments by the finger, geometrically referenced within a right-handed X-Y-Z Cartesian coordinate system defined as the finger tip being pointing in the negative Y-direction with Y=0 on the finger pad corresponding to a sensible center of feeling of the finger for pushing a button, the direction from the finger pad to the finger nail being the Z-direction and the plane X=0 being symmetrically dissecting the finger, the ambidextrous multi-function finger adaptor comprises:
a) a removable wearing means for fixably enclosing a portion of the finger covering at least the finger pad;
b) a first stylus tip, affixed to and projected from said removable wearing means at a first stylus location of Y=0 on the finger pad but offset from X=0 in the negative X-direction to a location between X=0 and the edge of the finger, for ergonomically operating an equipment with a first equipment user's hand of which said finger is a part of; and
c) a second stylus tip, affixed to and projected from said removable wearing means at a second stylus location of Y=0 on the finger pad but offset from X=0 in the positive X-direction to a location between X=0 and the edge of the finger, for ergonomically operating an equipment with a second equipment user's hand of which said finger is a part of.

2. The ambidextrous multi-function finger adaptor of claim 1 wherein said first stylus location of Y=0 on the finger pad is offset from X=0 in the negative X-direction to a location from about one third to about two thirds of the distance between X=0 and the edge of the finger.

3. The ambidextrous multi-function finger adaptor of claim 1 wherein said second stylus location of Y=0 on the finger pad is offset from X=0 in the positive X-direction to a location from about one third to about two thirds of the distance between X=0 and the edge of the finger.

4. The ambidextrous multi-function finger adaptor of claim 1 wherein said finger is a thumb, said first equipment user's hand is the user's right hand with the corresponding equipment being a cellular telephone being operated single-handed by the thumb through said first stylus tip.

5. The ambidextrous multi-function finger adaptor of claim 1 wherein said finger is a thumb, said second equipment user's hand is the user's left hand with the corresponding equipment being a cellular telephone being operated single-handed by the thumb through said second stylus tip.

6. The ambidextrous multi-function finger adaptor of claim 1 wherein said finger is a thumb, said second equipment user's hand is the user's right hand with the corresponding equipment being a lap top or a notebook computer whose touch pad being operated by the thumb through said second stylus tip.

7. The ambidextrous multi-function finger adaptor of claim 1 wherein said finger is a thumb, said first equipment user's hand is the user's left hand with the corresponding equipment being a lap top or a notebook computer whose touch pad being operated by the thumb through said first stylus tip.

8. The ambidextrous multi-function finger adaptor of claim 1 further comprising a third stylus tip, affixed to and projected from said removable wearing means at a third stylus location near X=0 and Y=0 on the finger pad, for ergonomically operating a graphic tablet of an equipment.

9. The ambidextrous multi-function finger adaptor of claim 8 wherein said finger is an index finger, a middle finger, a ring finger or a little finger with the corresponding equipment being a personal digital assistant.

10. The ambidextrous multi-function finger adaptor of claim 8, owing to the size of its stylus tips being smaller than the finger, further allows the operated equipments to be designed correspondingly smaller and more compact.

11. The ambidextrous multi-function finger adaptor of claim 1 further comprises a removable attaching means, located on said removable wearing means, for attaching the multi-function finger adaptor, while it is not being used for operating an equipment, onto the equipment for convenience of storage and prevention of misplacement.
